(19) United States
(12) Patent Application Publication
(10) Pub. No.: US 2024/0146864 A1
(43) Pub. Date: May 2, 2024

(54) LANDMARK IDENTIFICATION AND MARKING SYSTEM FOR A PANORAMIC IMAGE AND METHOD THEREOF

(71) Applicant: INSTITUTE FOR INFORMATION INDUSTRY, TAIPEI CITY (TW)

(72) Inventors: Jia-Hao WANG, TAIPEI CITY (TW); Zhi-Ying CHEN, TAIPEI CITY (TW); Hsun-Hui HUANG, TAIPEI CITY (TW); Chien-Der LIN, TAIPEI CITY (TW)

(73) Assignee: INSTITUTE FOR INFORMATION INDUSTRY, TAIPEI CITY (TW)

(21) Appl. No.: 17/989,900

(22) Filed: Nov. 18, 2022

(30) Foreign Application Priority Data
Oct. 26, 2022 (TW) 111140743

(51) Int. Cl. H04N 5/272; G06T 7/70; G06T 19/00; H04N 5/232; H04N 5/262

(52) U.S. Cl. CPC H04N 5/272; G06T 7/70; G06T 19/00; H04N 5/23238; H04N 5/2628; G06T 2207/30244; G06T 2219/004

(57) ABSTRACT

A landmark identification and marking system for a panoramic image is provided. The system includes a storage device and a back-end processor. The storage device stores an initial panoramic image, attitude information, motion tracking information, and a landmark list. The back-end processor performs steps of: adjusting a visual angle of the initial panoramic image to a designated angle according to a difference value between the visual angle and the designated angle; providing the adjusted initial panoramic image to a front-end processor for calculating and generating a panoramic image integrated with landmark objects in the virtual space.

### CROSS-REFERENCE TO RELATED APPLICATIONS

This application claims the priority benefit of TW application serial No. 111140743, filed on Oct. 26, 2022. The entirety of the above-mentioned patent application is hereby incorporated by reference herein and made a part of specification.

### BACKGROUND OF THE INVENTION

### 1. Field of the Invention

The present invention relates to a landmark identification and marking system and method thereof, and more particularly to a landmark identification and marking system for a panoramic image and method thereof.

### 2. Description of the Related Art

Surrounding images, also known as panoramic images, can be captured by a panoramic camera or multiple cameras with a 360-degree field of view. In addition to being used in vehicle systems to provide drivers with an overall driving vision, the panoramic images are also adopted for a virtual tour for users to have virtual interactions and experiences in a virtual space.

To create a virtual space through the panoramic images, a visual angle of the panoramic images need to be adjusted. On the other hand, it is necessary to create landmarks or interactive objects in the virtual space to improve the quality and stability of the interactions in the virtual space. However, the landmarks need to be marked manually, which takes a lot of time and effort. In addition to operational errors caused by manual work, it may also be necessary to re-shoot the panoramic images due to blurred images or obscured objects. Re-shooting the panoramic images leads to the operation of redoing the adjusting of the visual angle and the marking of the landmarks, which increases the workloads of the technicians.

### SUMMARY OF THE INVENTION

An objective of the present invention is to provide a landmark identification and marking system for a panoramic image. The system will adjust the visual angle and mark the landmarks to solve the problems caused by manual work.

To achieve the foregoing objective, the landmark identification and marking system for a panoramic image includes a storage device and a back-end processor.

The storage device stores an initial panoramic image, attitude information, motion tracking information, and a landmark list. The attitude information and the motion tracking information are measured by multiple sensors when the initial panoramic image is captured.

The back-end processor communicates with the storage device. The back-end processor calculates a difference value between a visual angle of the initial panoramic image and a designated angle, adjusts the visual angle of the initial panoramic image to the designated angle according to the difference value; and provides the adjusted initial panoramic image to a front-end processor for calculating and generating a panoramic image integrated with landmark objects in a virtual space.

Another landmark identification and marking system for a panoramic image is also provided in the present invention. The landmark identification and marking system for a panoramic image includes a storage device and a front-end processor.

The storage device stores an initial panoramic image and a landmark list.

The front-end processor communicates with the storage device. The front-end processor generates a camera coordinate system according to the initial panoramic image, performs a normalization and synchronization of the camera coordinate system of the panoramic image with a real coordinate system and a virtual coordinate system, generates at least one landmark object according to the landmark list, places the at least one landmark object in the virtual space corresponding to the initial panoramic image, and generates the panoramic image combined with the at least one landmark object located in the virtual space.

Another landmark identification and marking method for a panoramic image is also provided in the present invention. The method is performed by a front-end processor, and includes the following steps: calculating to generate a camera coordinate system according to the initial panoramic image, performing a normalization and a synchronization of the camera coordinate system of the panoramic image with a real coordinate system and a virtual coordinate system, generating at least one landmark object according to the landmark list, placing the at least one landmark object in the virtual space corresponding to the initial panoramic image, and generating the panoramic image combined with the at least one landmark object located in the virtual space.

The system and method of the present invention utilize the back-end processor to adjust the visual angle of the initial panoramic image to the designated angle according to the difference value, and utilize the front-end processor to synchronize and normalize the camera coordinate system with the real coordinate system and the virtual coordinate system. The camera coordinate system is used as a position basis for placing the at least one landmark object in the virtual space corresponding to the initial panoramic image, so as to generate the panoramic image.

The present invention utilizes the visual angle adjusting of the back-end processor and the landmark objects marking of the front-end processor to replace manual work.

In conclusion, the present invention overcomes problems of manual operation of the prior art, such as high time-consumption, heavy workload, and human errors. The present invention further improves the operation efficiency and the accuracy of landmark labeling.

### BRIEF DESCRIPTION OF THE DRAWINGS

FIG. 1 is a block diagram of a landmark identification and marking system for a panoramic image of the present invention.

FIG. 2 is a first flow chart of a landmark identification and marking method for a panoramic image of the present invention.

FIG. 3A is a schematic diagram of a first frame of the initial panoramic image without adjusting a visual angle.

FIG. 3B is a schematic diagram of the first frame of the initial panoramic image after adjusting the visual angle.

FIG. 3C is a schematic diagram of a second frame of the initial panoramic image without adjusting the visual angle.

FIG. 3D is a schematic diagram of the second frame of the initial panoramic image after adjusting the visual angle.

FIG. 4 is a second flow chart of a landmark identification and marking method for a panoramic image of the present invention.

FIG. 5 is a third flow chart of a landmark identification and marking method for a panoramic image of the present invention.

FIG. 6A is a schematic diagram of overlapping landmark objects in a virtual space.

FIG. 6B is a schematic diagram of the landmark objects in the virtual space after excluding the overlapping of objects.

### DETAILED DESCRIPTION OF THE INVENTION

Examples in the specification are for illustration only and do not limit the scope and meaning of the invention or any exemplified terms. Examples do not limit the scope and meaning of any words used in this invention. For example, “front-end” and “back-end” are used to distinguish different processors and should not limit their meanings. The present invention is not limited to various embodiments presented in this specification. The present invention is particularly described by the following examples. The following examples are for illustration only. For those skilled in this technical field, changes and modifications may be made without departing from the spirit and scope of the present disclosure. For example, the terms “device, processor, and sensor” may include physical objects or have an extended meaning of virtual objects. The term “connect” or “communicate” herein includes any direct electrical connection and indirect electrical connection, as well as wireless or wired connection. For example, the description describes a first device communicating with a second device, it means that the first device can be directly connected to the second device, or indirectly connected to the second device through other devices or connecting methods.

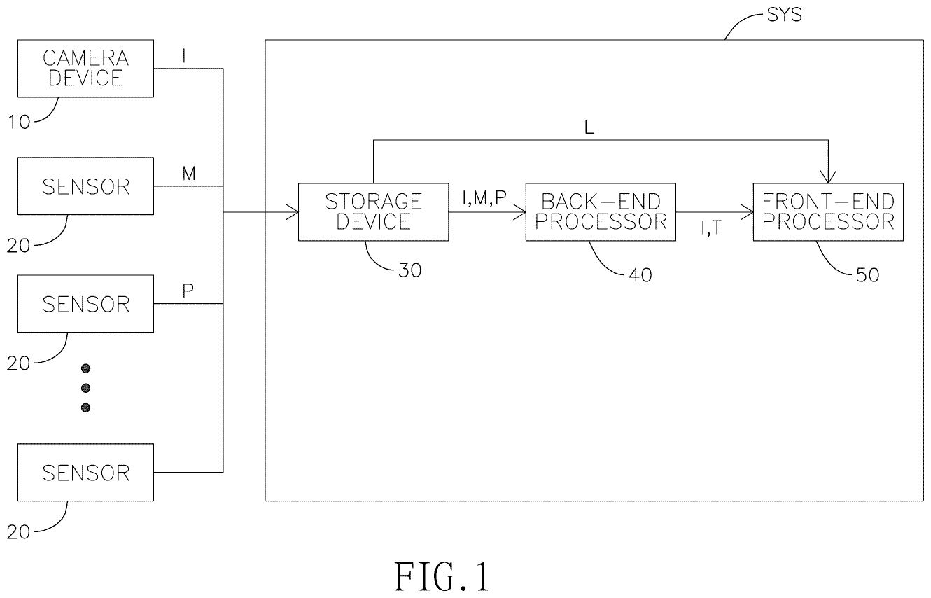

With reference to FIG. 1, the present invention is a landmark identification and marking system for a panoramic image SYS including a storage device 30, a back-end processor 40 and a front-end processor 50. The input information of the system SYS comprises initial panoramic image I, attitude information P, and motion tracking information M. The initial panoramic image I is captured by a camera device 10 on a target scene. The attitude information P and the motion tracking information M correlated with the initial panoramic image I are sensed by multiple sensors 20 while the initial panoramic image I is captured. In another embodiment, the initial panoramic image I, the attitude information P and the motion tracking information M may be retrieved from another storage device, wherein the attitude information P and the motion tracking information M are also correlated with the initial panoramic image I.

The attitude information P includes data such as attitude angle, acceleration and magnetic field. The motion tracking information M includes latitude and longitude data of the camera device 10 at the time of shooting.

The sensors 20 may include an attitude sensor, an inertial measurement unit (IMU), a GPS, a geomagnetic meter, an accelerometer, a gyroscope, barometers, etc.

The storage device 30 of the present invention can communicate with the camera device 10 and the sensors 20 to obtain the initial panoramic image I transmitted by the camera device 10, as well as the attitude information P and the motion tracking information M sensed by the sensors 20. The storage device 30 of the present invention can also communicate with another storage device to obtain the initial panoramic image I, the attitude information P and the motion tracking information M stored by the another storage device.

The storage device 30 also stores a pre-established landmark list L. The landmark list L records at least one landmark and real coordinates and altitude information of each landmark. The real coordinates can be represented by latitude and longitude. The storage device 30 can be a memory, a hard disk or a server. The at least one landmark stored on the landmark list L can include buildings or other obvious and identifiable objects in the target scene.

The back-end processor 40 communicates with the storage device 30. The back-end processor 40 adjusts the visual angle of the initial panoramic image I and transmits the adjusted initial panoramic image I to the front-end processor 50. The back-end processor 40 can be an electronic device with computing functions such as a cloud server, a controller, a computer, etc., and the back-end processor 40 can communicate with the storage device 30 through wired or wireless communication technology.

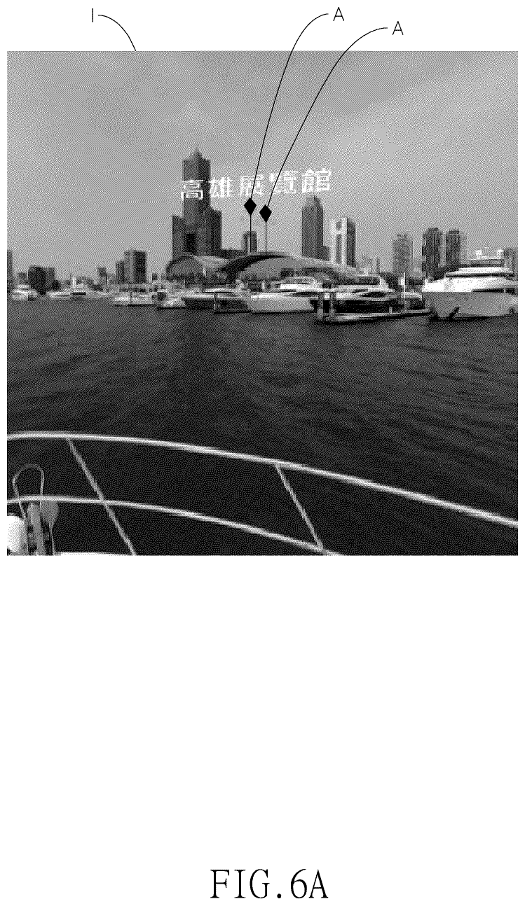

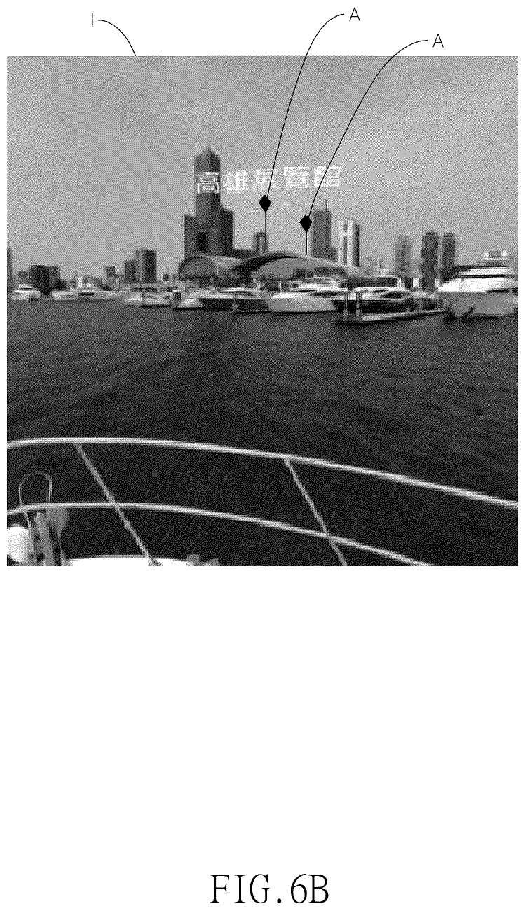

The front-end processor 50 communicates with the storage device 30 and the back-end processor 40. The front-end processor 50 generates a camera coordinate system of the initial panoramic image I, synchronizes and normalizes the camera coordinate system with a real coordinate system and a virtual coordinate system, places at least one landmark object A shown in FIG. 6A and FIG. 6B in the virtual space corresponding to the initial panoramic image I according to the real coordinates of each landmark in the landmark list L, and generates the panoramic image I combined with the at least one landmark object A located in the virtual space.

At least one landmark object A may include landmark names and icons. The front-end processor 50 can be an electronic device with computing functions such as a mobile phone, a controller, a computer, and a virtual reality (VR) host. The front-end processor 50 can communicate with the storage device 30 and the back-end processor 40 through wired or wireless communication technology.

Further explanation is provided below. The landmark identification and marking method for a panoramic image of the present invention is performed by the back-end processor 40 and the front-end processor 50.

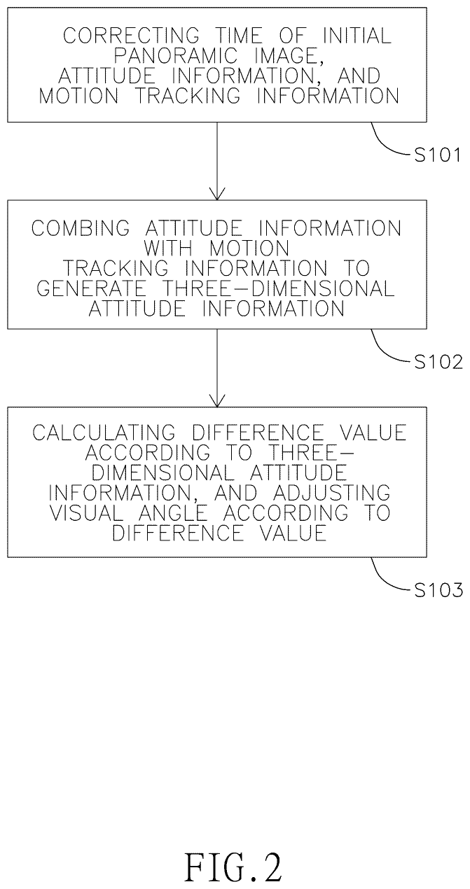

With reference to FIG. 2, the back-end processor 40 first executes the adjustment of the visual angle of the initial panoramic image I, including the following steps:

S101: correcting the time of the initial panoramic image I, the attitude information P, and the motion tracking information M.

S102: combing the attitude information P with the motion tracking information M to generate three-dimensional attitude information T.

S103: calculating the difference value according to the three-dimensional attitude information T, and adjusting the visual angle according to the difference value.

In step S101, the back-end processor 40 uses a Dynamic Time Warping algorithm to perform dynamic time correction of various data and aligns the time axis of the initial panoramic image I, the attitude information P, and the motion tracking information M to ensure the time synchronization of the initial panoramic image I, the attitude information P, and the motion tracking information M.

In step S102, the back-end processor 40 estimates the three-dimensional attitude information T by combining the attitude information P and the acceleration, angular acceleration, geomagnetic angle and other data in the motion tracking information M that have aligned with the time axis. The three-dimensional attitude information T includes attitude angles, moving speeds and moving directions of the camera device 10 when shooting the initial panoramic image I.

Further, the back-end processor 40 calculates the attitude angle through the angular acceleration, and corrects the error caused by time drift of the angular acceleration through the acceleration data, so as to obtain a stable attitude angle. The attitude angle calculated by the angular acceleration and acceleration only get the attitude of the roll angle (roll axis) and pitch angle (pitch axis). The yaw angle (yaw axis) is estimated by the angular acceleration offset by time. Therefore, the back-end processor 40 corrects the yaw angle (yaw axis) through the geomagnetic angle and the Kalman filter, so as to obtain the three-dimensional attitude information T with precise attitude angle.

In step S103, the back-end processor 40 calculates the difference value between the visual angle of each frame in the initial panoramic image I and a preset designated angle according to the three-dimensional attitude information T. Then the back-end processor 40 adjusts the visual angle to be consistent with the designated angle according to the difference value.

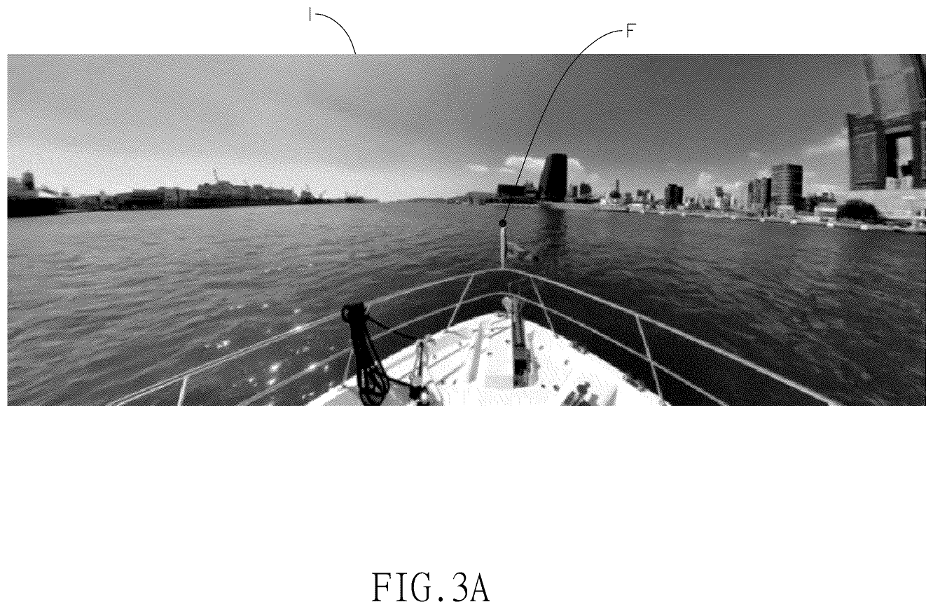

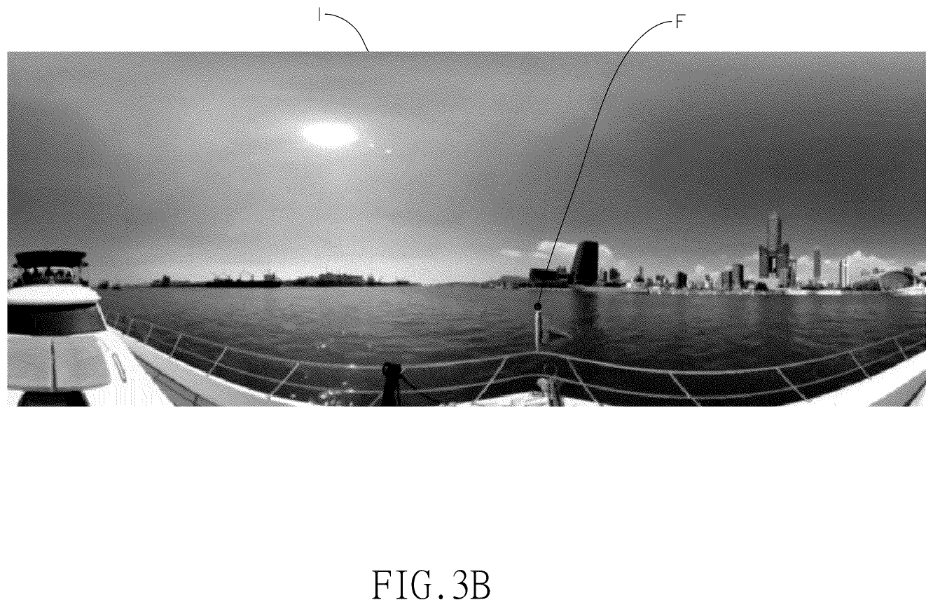

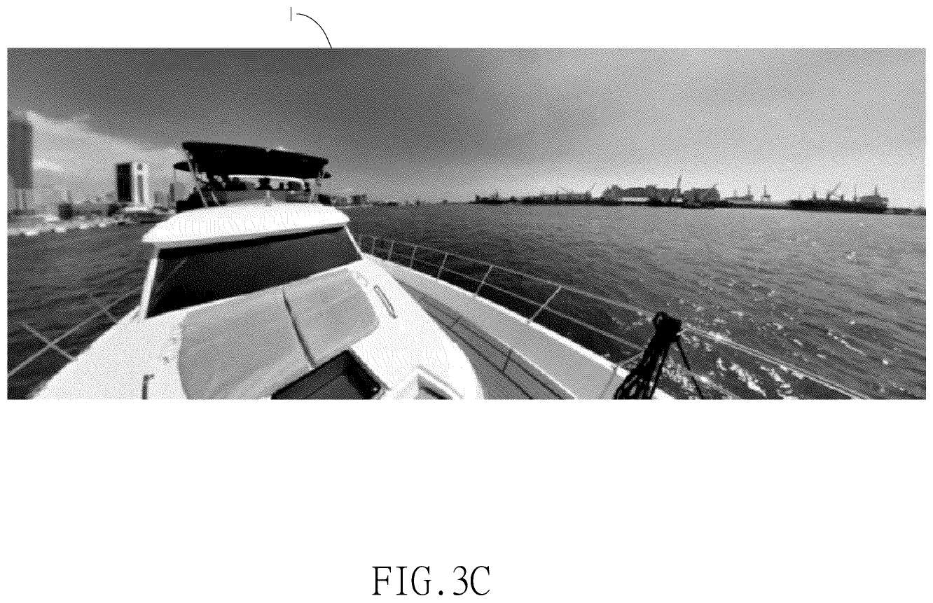

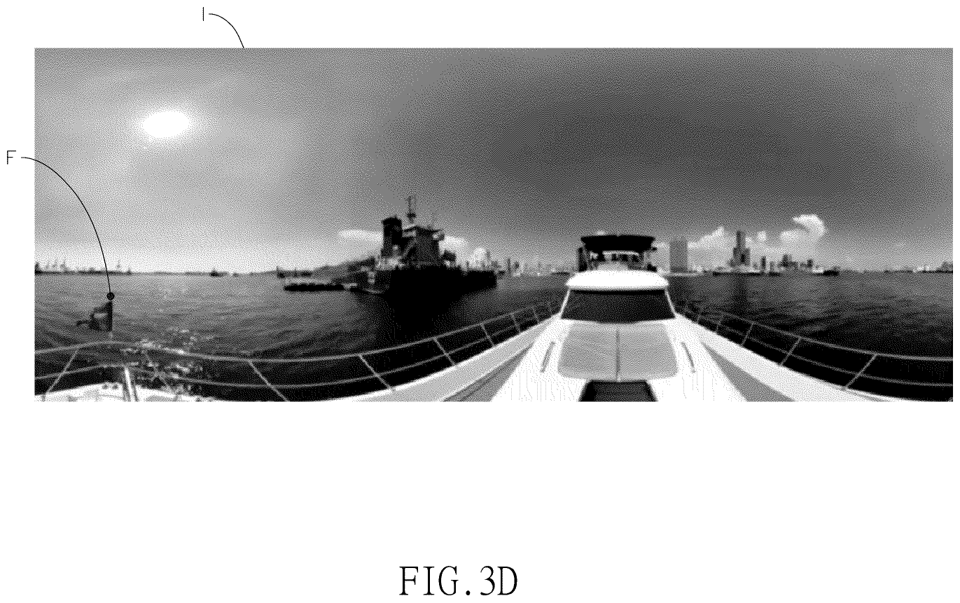

With reference to FIG. 3A to FIG. 3D, when adjusting the visual angle, the back-end processor 40 can move the visual angle and adjust the ratio of the visual angle. Taking the visual angle of FIG. 3A as an example, the back-end processor 40 displays the visual angle as a 360-degree spherical image shown in FIG. 3B. The designated angle can be designated to keep the visual positioning point F in the frame. The difference value is the distance to adjust the visual positioning point F into the frame, so as to prevent the visual positioning point F from leaving the frame. FIG. 3A to FIG. 3D use the top of the flag as the visual positioning point F. In other words, the designated angle is to keep the flag in the frame.

Without adjustment of the visual angle, the flag in FIG. 3C has deviated from the designated angle, and the flag (i.e., the visual positioning point F) cannot be seen in the frame. In FIG. 3D, the back-end processor 40 adjusts the flag into the visual angle according to the difference value, which means that the visual angle is adjusted to the designated angle. The back-end processor 40 transmits the three-dimensional attitude information T and the adjusted initial panoramic image I to the front-end processor 50 for subsequent operations.

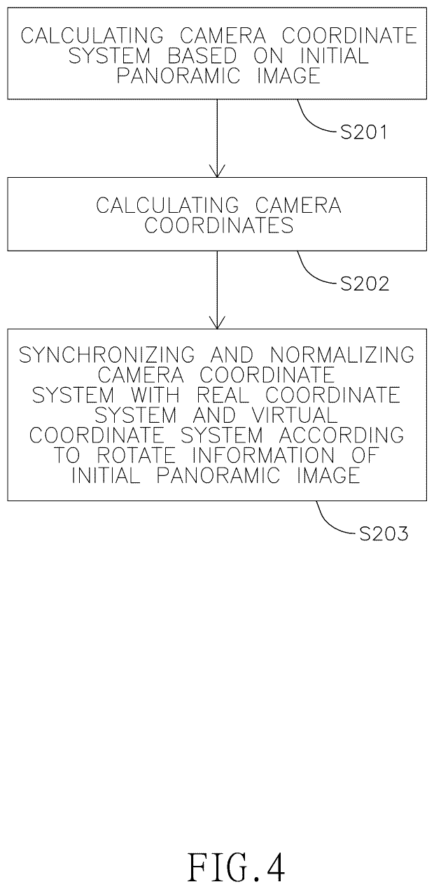

With reference to FIG. 4, the front-end processor 50 further performs the combination of multiple coordinate systems, including the following steps:

S201: calculating the camera coordinate system based on the initial panoramic image I.

S202: calculating camera coordinates.

S203: synchronizing and normalizing the camera coordinate system with the real coordinate system and the virtual coordinate system according to rotate information of the initial panoramic image I.

In step S201, the front-end processor 50 calculates the distance and relative position between each point of each frame of the initial panoramic image I and a shooting point of the initial panoramic image I to establish the camera coordinate system. The camera coordinate system is a relative coordinate system, representing the relative distance between each position and the shooting point where the camera device 10 shoots the initial panoramic image I.

In step S202, the front-end processor 50 calculates the camera coordinate system according to the PNP (Perspective-n-Point) algorithm, and calculates the camera coordinates of each point in each frame of the initial panoramic image I.

When the camera device 10 captures the initial panoramic image I, the visual angle of the initial panoramic image I will rotate due to the movement of the camera device 10. Because the camera coordinate system is a relative coordinate system, when the visual angle is rotated or moved, the relative distance between each point of each frame of the initial panoramic image I and the shooting point of the initial panoramic image I will change, which means the camera coordinates of each point will change.

The front-end processor 50 calculates the rotate information between each frame. The rotate information records the camera coordinates of each point in each frame and the changes of the camera coordinate.

In step S203, the front-end processor 50 calculates the relative position between camera coordinate of each point in each frame and the real coordinates through the Rodrigue's rotation formula to synchronize each camera coordinate with the real coordinates in the real coordinate system. The front-end processor 50 can align the coordinates of the camera coordinate system and the coordinates of the real coordinate system to complete the correspondence between the camera coordinate system and the real coordinate system.

The virtual coordinate system corresponds to the virtual space. The virtual space is pre-established, and the virtual coordinate system corresponds to the real coordinate system. The camera coordinate system has been synchronized with the real coordinate system. The front-end processor 50 synchronizes and normalizes the camera coordinate system with the virtual coordinate system through the real coordinate system, so as to complete the synchronization and normalization of the camera coordinate system, the real coordinate system and the virtual coordinate system.

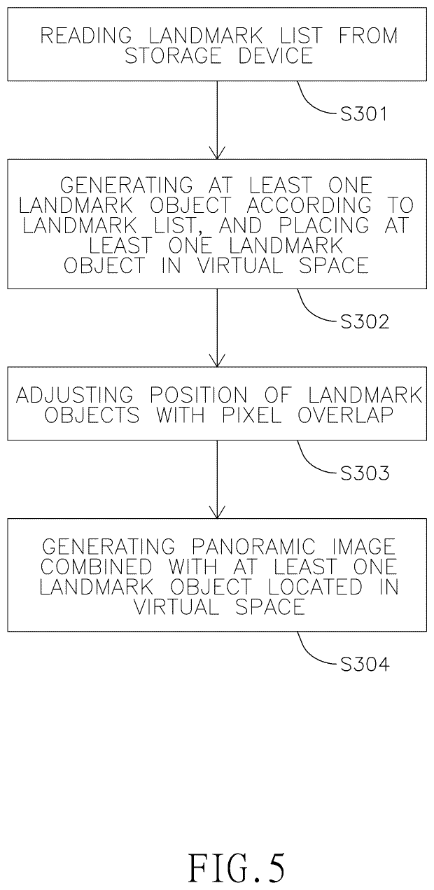

With reference to FIG. 5, the front-end processor 50 performs the marking of the landmarks, including the following steps:

S301: reading the landmark list L from the storage device 30.

S302: generating the at least one landmark object A according to the landmark list L, and placing the at least one landmark object A in the virtual space.

S303: adjusting the position of the at least one landmark object A with pixel overlap.

S304: generating the panoramic image combined with the at least one landmark object A located in the virtual space.

In step S302, the front-end processor 50 generates at least one landmark object A corresponding to at least one landmark of the landmark list L. The front-end processor 50 converts the two-dimensional coordinates of each landmark recorded in the landmark list L into the three-dimensional space of the virtual space through Geohash algorithm. The front-end processor 50 places each landmark object A in the virtual space corresponding to the initial panoramic image I according to the converted real coordinates. The position where the landmark object A is placed corresponds to the coordinates of the real coordinate system.

With reference to FIGS. 6A and 6B, since the distance between the at least one landmark object A and each viewer are different, when the front-end processor 50 places at least one landmark object A in the virtual space, the text or icons of each landmark object A may overlap each other. The text of some landmark objects A cannot be displayed, or the icons of some landmark objects A are blocked.

To avoid overlapping landmark object A affecting the user's operating experience, in the step of S303, the front-end processor 50 captures multiple frames of the initial panoramic image I at different angles and compares the frames from different angles. The front-end processor 50 calculates every pixel and distance between pixels of different landmark objects A in the virtual space. As shown in FIG. 6B the front-end processor 50 re-locates the overlapping landmark objects A to eliminate the problem of overlapping.

In summary, the back-end processor 40 calculates the difference value between the visual angle of the initial panoramic image I and the preset designated angle, so as to adjust the visual angle of the initial panoramic image I through the difference value. The front-end processor 50 uses synchronization and normalization of the camera coordinate system of the initial panoramic image I, the real coordinate system and the virtual coordinate system as a coordinate basis for placing at least one landmark object A, completing the labeling of each landmark. The panoramic image generated by the present invention is combined with at least one landmark object A in the virtual space, and the panoramic image can be applied in the related industries of virtual reality.

Compared with the prior art, the present invention changes vision angle adjusting and landmark marking that were manually operated in the past to be automatically performed by the system to overcome the problem of high time-consumption and heavy workload. The present invention improves the efficiency of vision angle adjusting and landmark marking. The present invention further prevents visual errors that are unavoidable in manual operations, and improves the accuracy of vision angle adjusting and landmark marking.

What is claimed is:

1. A landmark identification and marking system for a panoramic image, comprising:
a storage device, being configured to store an initial panoramic image, attitude information, motion tracking information, and a landmark list, wherein, the attitude information and the motion tracking information are measured by multiple sensors when the initial panoramic image is captured;
a back-end processor, communicating with the storage device, and being configured to:
calculate a difference value between a visual angle of the initial panoramic image and a designated angle;
adjust the visual angle of the initial panoramic image to the designated angle according to the difference value; and
provide the adjusted initial panoramic image to a front-end processor for generating a panoramic image being integrated with at least one landmark object in a virtual space.

2. The system as claimed in claim 1, wherein the front-end processor communicates with the storage device and the back-end processor, and the front-end processor is further configured to:
calculate a camera coordinate system based on the initial panoramic image;
synchronize and normalize the camera coordinate system with a real coordinate system and a virtual coordinate system.

3. The system as claimed in claim 1, wherein the front-end processor communicates with the storage device and the back-end processor, and the front-end processor is further configured to:
generate the at least one landmark object according to the landmark list, and place the at least one landmark object in the virtual space;
generate the panoramic image combined with the at least one landmark object located in the virtual space.

4. The system as claimed in claim 3, wherein the back-end processor is further configured to:
correct time of the initial panoramic image, the attitude information, and the motion tracking information, and align a time axis of the initial panoramic image, the attitude information, and the motion tracking information;
combine the attitude information with the motion tracking information to generate three-dimensional attitude information;
calculate the difference value according to the three-dimensional attitude information.

5. The system as claimed in claim 2, wherein the front-end processor is further configured to:
calculate a camera coordinate of each point in each frame of the initial panoramic image;
synchronize a camera coordinate of each point with a real coordinate of the real coordinate system according to rotate information of each frame of the initial panoramic image;
synchronize and normalize the camera coordinate system with the real coordinate system and the virtual coordinate system according to the corresponding camera coordinates and the real coordinates.

6. The system as claimed in claim 4, wherein the landmark list records at least one landmark and a real coordinate of each landmark;
the front-end processor communicates with the storage device and the back-end processor, and the front-end processor is further configured to:
create the at least one landmark object according to the at least one landmark;
calculate a virtual coordinate corresponding to the real coordinate;
place the at least one landmark object in the virtual space established by the virtual coordinate system according to the virtual coordinate.

7. The system as claimed in claim 6, wherein the front-end processor communicates with the storage device and the back-end processor, and the front-end processor is further configured to:
calculate a relative distance between each pixel of different landmark objects according to each frame of the panoramic image;
adjust the position of the different landmark objects with pixel overlap.

8. A landmark identification and marking system for a panoramic image, comprising:
a storage device, being configured to store an initial panoramic image and a landmark list;
a front-end processor, communicating with the storage device, and being configured to:
calculate a camera coordinate system based on the initial panoramic image;
synchronize and normalize the camera coordinate system with a real coordinate system and a virtual coordinate system;
generate the at least one landmark object according to the landmark list, and place the at least one landmark object in a virtual space;
generate the panoramic image combined with the at least one landmark object located in the virtual space.

9. The system as claimed in claim 8, comprising:
a back-end processor, communicating with the storage device and the front-end processor, and being configured to:
calculate a difference value between a visual angle of the initial panoramic image and a designated angle;
adjust the visual angle of the initial panoramic image to the designated angle according to the difference value; and
provide the adjusted initial panoramic image to the front-end processor.

10. The system as claimed in claim 1, wherein the storage device further stores attitude information and motion tracking information;
the attitude information and the motion tracking information are measured by multiple sensors when the initial panoramic image is captured; and
the back-end processor is further configured to:
correct time of the initial panoramic image, the attitude information, and the motion tracking information, and align a time axis of the initial panoramic image, the attitude information, and the motion tracking information;
combine the attitude information with the motion tracking information to generate three-dimensional attitude information;
calculate the difference value according to the three-dimensional attitude information.

11. The system as claimed in claim 8, wherein the front-end processor is further configured to:
calculate a camera coordinate of each point in each frame of the initial panoramic image;
synchronize a camera coordinate of each point with a real coordinate of the real coordinate system according to a rotate information of each frame of the initial panoramic image;
synchronize and normalize the camera coordinate system with the real coordinate system and the virtual coordinate system according to the corresponding camera coordinates and the real coordinates.

12. The system as claimed in claim 8, wherein the landmark list records at least one landmark and a real coordinate of each landmark;
the front-end processor is further configured to:
create the at least one landmark object according to the at least one landmark;
calculate a virtual coordinate corresponding to the real coordinate;
place the at least one landmark object in the virtual space established by the virtual coordinate system according to the virtual coordinate.

13. The system as claimed in claim 8, wherein the front-end processor is further configured to:
calculate a relative distance between each pixel of different landmark objects according to each frame of the panoramic image;
adjust the position of the different landmark objects with pixel overlap.

14. A landmark identification and marking method for a panoramic image, executed by a front-end processor and comprising the following steps:
calculating a camera coordinate system based on an initial panoramic image;
synchronizing and normalizing the camera coordinate system with a real coordinate system and a virtual coordinate system;
generating at least one landmark object according to a landmark list, and placing the at least one landmark object in a virtual space;
generating the panoramic image combined with the at least one landmark object located in the virtual space.

15. The method as claimed in claim 14, further comprising the following steps operated by a back-end processor:
reading the initial panoramic image stored in a storage device;
calculating the difference value between a visual angle of the initial panoramic image and a designated angle;
adjusting the visual angle of the initial panoramic image to the designated angle according to the difference value; and
providing the adjusted initial panoramic image to the front-end processor.

16. The method as claimed in claim 15, further comprising the following steps operated by the back-end processor:
reading attitude information and motion tracking information stored in the storage device;
correcting time of the initial panoramic image, the attitude information, and the motion tracking information, and aligning a time axis of the initial panoramic image, the attitude information, and the motion tracking information;
combining the attitude information with the motion tracking information to generate three-dimensional attitude information;
calculating a difference value according to the three-dimensional attitude information.

17. The method as claimed in claim 14, further comprising the following steps operated by the front-end processor:
calculating a camera coordinate of each point in each frame of the initial panoramic image;
synchronizing a camera coordinate of each point with a real coordinate of the real coordinate system according to a rotate information of each frame of the initial panoramic image;
synchronizing and normalizing the camera coordinate system with the real coordinate system and the virtual coordinate system according to the corresponding camera coordinates and the real coordinates.

18. The method as claimed in claim 14, further comprising the following steps operated by the front-end processor:
reading at least one landmark from the landmark list, and a real coordinate of the at least one landmark;
creating the at least one landmark object according to the at least one landmark;
calculating a virtual coordinate corresponding to the real coordinate, placing the at least one landmark object in the virtual space established by the virtual coordinate system according to the virtual coordinate.

19. The method as claimed in claim 14, further comprising the following steps operated by the front-end processor:
calculating a relative distance between each pixel of different landmark objects according to each frame of the panoramic image;
adjusting the position of the different landmark objects with pixel overlap.
